(19) United States
(12) Patent Application Publication
(10) Pub. No.: US 2014/0370481 A1
(43) Pub. Date: Dec. 18, 2014

(54) POLYGRAPH REPORT SYSTEM THAT IS EQUIPMENT AGNOSTIC

(71) Applicant: Ruiz Protective Services, Inc., Austin, TX (US)

(72) Inventor: Hector Ruiz, Austin, TX (US)

(21) Appl. No.: 13/916,330

(22) Filed: Jun. 12, 2013

(51) Int. Cl. G09B 5/00

(52) U.S. Cl. CPC G09B 5/00
USPC 434/327

(57) ABSTRACT

Described herein are techniques related to a polygraph report system that is equipment agnostic. This Abstract is submitted with the understanding that it will not be used to interpret or limit the scope or meaning of the claims.

### BACKGROUND

A polygraph test is often used during the investigative stage of the criminal justice process and, in some instances, the polygraph results are sometimes presented in court as evidence. Polygraph tests also play a role in parole and probation supervision. Also, a polygraph test may be used in a hiring or other human resources situation. In addition, polygraph examinations are also used for national security, intelligence, and counterintelligence activities of the United States and foreign nations.

The term “polygraph” literally means “many writings.” However, as used herein, the term “polygraph” refers to any kind of lie detector, and most typically, to an instrument for recording physiological phenomena such as blood pressure, pulse rate, and respiration of a human subject as the subject listens and responds to questions put to him by an operator or polygraph examiner. The recorded data are then used as the basis for making a judgment as to whether or not the subject is lying.

A typical polygraph examination includes three phases: a pre-test interview, a testing phase, and an analysis phase. Typically, each of these phases involves manual adjustment and creation of paperwork regarding the subject, the test, and reporting the results. Each aspect is typically done manually and no association between data points is gathered, managed, and associated with each other.

During the pre-test interview, the examiner completes required paperwork and talks with the examinee about the test, answering any questions the examinee might have. It is during this phase that the examiner will discuss the test questions and familiarize the examinee with the testing procedure.

In the next phase (e.g., the testing phase), the examiner administers the actual polygraph test using a polygraph machine. The polygraph test itself typically includes an ordered combination of relevant questions about an issue, control questions that provide physiological responses for comparison, and irrelevant (or neutral) questions that also provide responses or the lack of responses for comparison, or act as a buffer. During this testing phase, the examiner administers and collect a number of polygraph charts.

Following this, the examiner analyzes the charts and renders an opinion as to the truthfulness of the examinee.

### BRIEF DESCRIPTION OF THE DRAWINGS

FIG. 1 is an example scenario that illustrates conducting of a polygraph examination in a network environment in accordance with the implementations described herein.

FIG. 2 is an example system in accordance with one or more implementations described herein.

FIG. 3 is an example process chart illustrating an example method for generating polygraph examinations report that is polygraph equipment agnostic.

FIG. 4 is a high-level block diagram illustrating an example computer system to implement the technology described herein

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein is a technology for a polygraph report system that is equipment agnostic. That is, a polygraph report system built in accordance with the technology described herein is not dependent upon the specific type or brand of polygraph equipment used to administer the polygraph test to an examiner.

For example, a computing device selects a set of test questions from a database based upon a client request. The client may be, for example, a parole officer, an examinee's employer, a psychologist, etc. Alternatively, the client may be a computing system used by people such as a parole officer, an examinee's employer, a psychologist, etc.

Upon selection of the set of test questions, the examiner utilizes the polygraph equipment to facilitate him in assessing a degree of examinee's truthfulness in answering the set of test questions. For example, the polygraph equipment's proprietary software provides analysis on physiological changes of the examinee during the conduct of the polygraph examination. In this example, the polygraph equipment generates results and the results may be directly communicated or manually imported to the computing device. The results, for example, include test questions, answers to the test questions, polygraph equipment response analysis, and the like. Furthermore, the results include examiner's comments on the answers to the test questions. These results are then entered and stored into the computing device. The computing device, in turn, communicates this entry to update the database. For example, the database is accessible through a network environment.

Depending upon authorization level of an individual who plays a role to a particular polygraph examination, access to contents in the database is controlled and limited. For example, a parole officer is limited to access the polygraph examination reports; however, the parole officer is not allowed to perform modification on the accessed data. In another example, the examiner to the particular polygraph examination may edit conclusions that he entered in previous polygraph examination concerning the same examinee.

### Exemplary Scenario

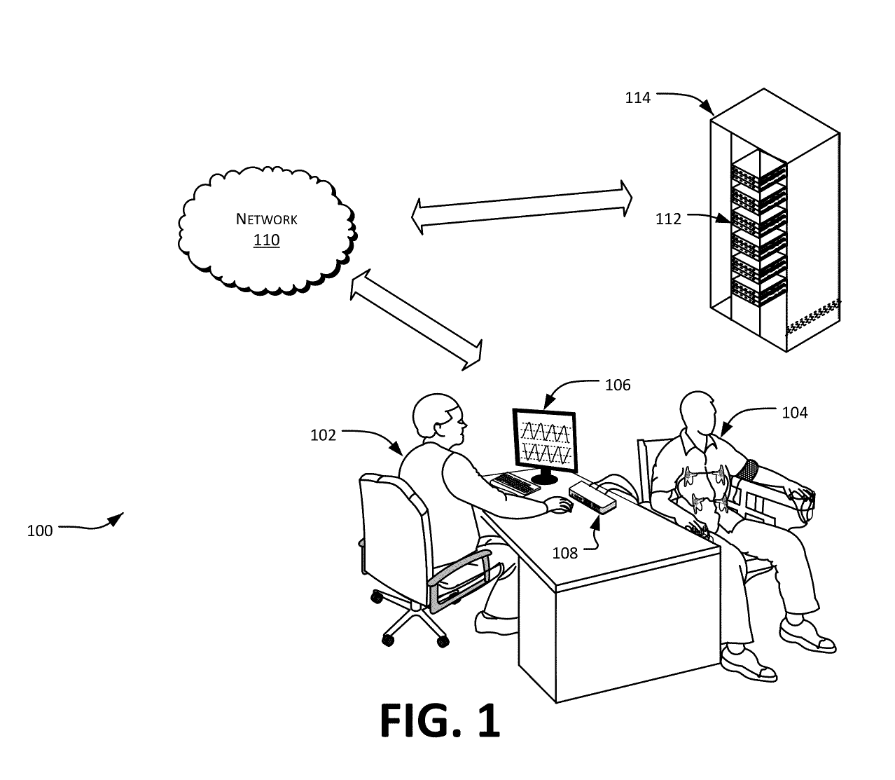

FIG. 1 illustrates an example scenario 100 that shows conducting of a polygraph examination in a network environment in accordance with the technologies described herein. Scenario 100 shows an examiner 102, an examinee 104, computing device 106, polygraph equipment 108, network 110, a dataset 112 and a database 114. The arrangement in scenario 100 illustrates, for example, data management of polygraph examination reports and access to these reports through the network environment.

As an example of present implementations herein, the polygraph examination in scenario 100 is agnostic to a type of polygraph equipment that is utilized during the polygraph examination. That is, the computing device 106 receives results that were generated by the polygraph equipment 108 independent of the type of the polygraph equipment. For example, a certain type of polygraph equipment utilizes a sophisticated state-of-the-art system in analyzing physiological changes of the examinee to generate the results. In another example, a certain type of polygraph equipment utilizes a conventional polygraph system that implements manual analysis of the physiological changes to generate the same results. In these two examples, the computing device 106 receives and stores these results regardless of how they were generated.

As an example of present implementations herein, the polygraph equipment generated results include the questions to the actual polygraph tests, the corresponding answers to these questions, and the polygraph equipment system analysis of the physiological changes during the answering of these questions. Furthermore, the results include, for example, audio and video of the examinee 104 during the conduct of the polygraph examination.

The computing device 106 may directly receive the polygraph equipment results from the examiner 102 who encodes it, or the computing device 106 may be configured to directly communicate with the polygraph equipment 108. When the examiner 102 encodes the polygraph equipment results, the polygraph equipment is utilized as a tool. That is, the polygraph equipment is external to the system of the computing device 106. When the computing device 106 is configured to directly receive the results from the polygraph equipment such as when the proprietary system of the polygraph equipment is known, then the polygraph equipment may be a part of the system in the computing device 106. Furthermore, the computing device 106 may receive the results partly through manual encoding, and partly through direct communications from the polygraph equipment.

As shown, the polygraph equipment 108 is utilized as a tool for the polygraph examination. For example, the examiner 102 encodes the results that were generated by the polygraph equipment 108. In this example, the examiner 102 additionally encodes his comments, which are based at least in part from the results, into the computing device 106. The comments, for example, include examiner's analysis and personal observation of the answers to each of the actual polygraph test question. Furthermore, the comments include examiner's analysis of the overall results. The encoded results and comments, for example, are illustrated in part below.

| | |
|---|---|
| Test Question No. 1 | Did you lie on any questions |
| | with regard to your criminal |
| | history? |
| Examinee's Answer | NO |
| Polygraph Equipment | No Deception Indicated |
| Response Analysis | |
| Examiner's Comments | Examiner confirms no deception |
| | indicated |

With continuing reference to FIG. 1, the examiner 102 encodes, for example, the above illustrated results independent of how the polygraph equipment 108 derived the results and more particularly, the response analysis portion of the results. In other words, whether the proprietary software of the polygraph equipment 108 utilizes different automated approaches in computing physiological changes such as examinee's body temperature, pulse rate, etc. to analyze the examinee's response to a particular question, the examiner 102 does not encode these details except the generated summary of the response analysis. The generated summary, for example, indicates that no deception is detected on the examinee's response (as illustrated in the results above).

Upon encoding of the results and comments, the computing device 106 generates a report that is based from the encoded results and comments. For example, the computing device 106 is configured to include in the report important portions of the results and highlight corresponding answers and examiner's comments. Additionally, the generated report includes the video of the polygraph examination, previous polygraph examination reports, and the like. Depending upon access authorization level of the requesting client, the computing device 106 determines this access authorization level and correspondingly generates the report that is authorized for access by the client.

In one or more implementations, the computing device 106 allows participating parties (e.g., investigators, parole/probation officers, therapists, human resources personnel, and the like) to have access to the examinee's electronic record after the examinee completes the pre-test questionnaire before (and not after) the polygraph is conducted. In these implementations, these participating parties will not be able to alter any information entered by the examinee; however, they may supplement that information. The computing device 106 will track who accessed and supplemented the examinee's electronic record.

In other embodiments, the computing device 106 utilizes automated approaches in providing its own estimate of the overall truthfulness of the answers in the results. For example, a YES answer to a control question is configured by the automated approach to generate zero point while a NO answer generates a one point. In this example, the computing device 106 includes in the report the estimated overall truthfulness in addition to other details such as the video, important portions of the results, etc. The report, for example, is illustrated in part below:

| | |
|---|---|
| Name of Examinee | John Doe |
| Requesting Client | Parole Officer Jane Doe |

SAMPLE REPORT

| | |
|---|---|
| Test Questions 3, 5, . . . etc. | Question 3. Did you lie . . . ? |
| | Question 5. Did you accept . . . ? |
| Examinee's Answers to Questions | Question 3. YES |
| 3, 5, . . . etc. | Question 5. NO |
| Polygraph Equipment Response | Question 3. No Deception |
| Analysis For Questions 3, 5 | Detected |
| | Question 5. No Deception |
| | Detected |
| Overall Polygraph Equipment | No Deception Detected |
| Response Analysis | |
| Examiner's Analysis of Overall Results | Examiner confirms no deception |
| | is detected |
| Computing Device System Estimate of | Examinee Passed Examination |
| Truthfulness | |
| Additional Information | Video can be seen at URL link: |
| | www.url-video-sample.com |

As an example of present implementations herein, the computing device 106 stores the report and the encoded results and comments to the dataset 112 through the network 110.

For example, the dataset 112 stores all information for a particular polygraph examination scenario. The information includes the current and previous reports, results, and comments. For example, the information includes an examinee's name, a client's identification, and/or names of other third parties such as a judge, parole officer, etc. who plays a role to the current polygraph examination. The client, for example, is an individual or agency who is requesting the current polygraph examination.

Furthermore, the dataset 112 contains the selected set of test questions for the polygraph examination. For example, the selected set of test questions contains a set of pre-test questions and a set of regular test questions. In this example, the pre-test questions include personal information questions to the examinee 104 while the set of regular test questions (i.e., actual polygraph test questions) include relevant, irrelevant, and control questions.

The network 110 is a generic label for remote services offered over a computer network (e.g., the Internet) that entrusts a user's data, software, and/or computation.

The database 114 stores a collection of the dataset 112 and a pool of test questions for the polygraph examination. The pool of test questions, for example, includes pre-defined set of pre-test questions and pre-defined set of regular test questions. Although FIG. 1 shows a single dataset 112, in reality, the database 114 stores multiple dataset 112 that correspond to different polygraph examination cases.

### Exemplary System

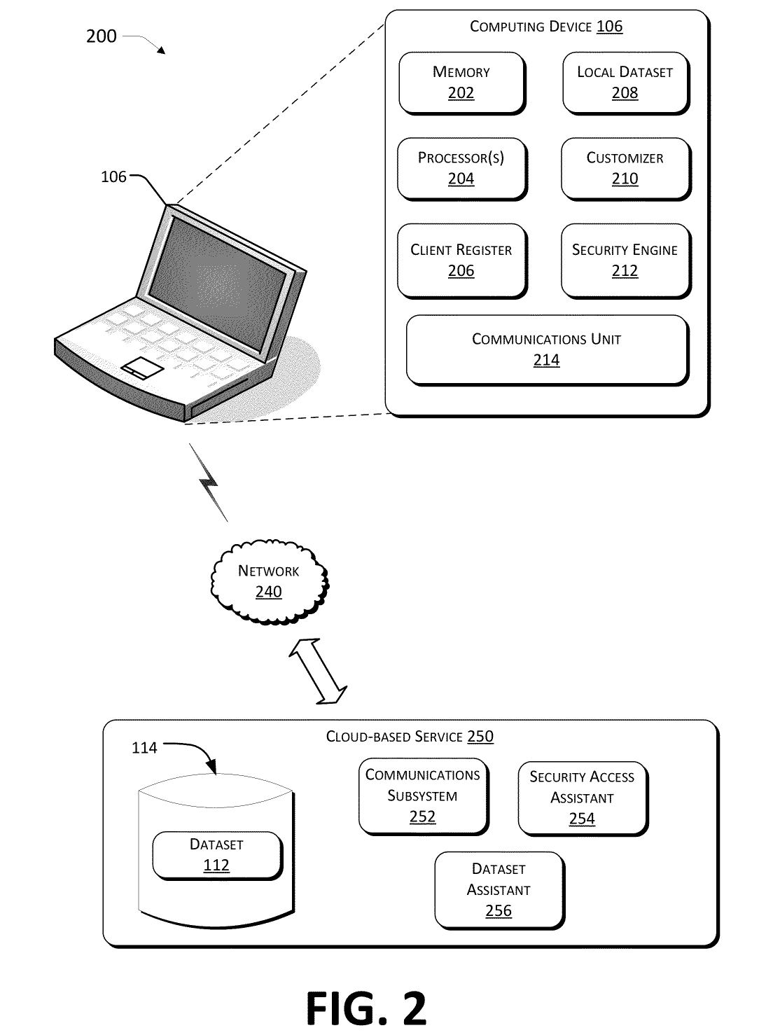

FIG. 2 illustrates example system 200 for implementing the technology described herein. The system 200 includes the computing device 106 (such as a laptop computer), a network 240, and cloud-based service 250.

As depicted, the computing device 106 includes a memory 202, one or more processor(s) 204 (or simply a processor), a client register 206, a local dataset 208, a customizer 210, a security engine 212, and a communications unit 214. These functional components may be separate or some combination of hardware units. Alternatively, the components may be implemented, at least in part, in software and thus be stored in the memory 202 and executed by the processors 204.

The client register 206 selects the set of test questions based upon the client request. For example, the set of test questions will be different for a requesting parole officer client, for a private employer client, or for a judge client such as when the examinee (e.g., examinee 104) is a defendant to a pending criminal case. In this example, the client register 206 is configured to facilitate downloading of the selected set of test questions from the cloud-based service 250. Furthermore, the client register 206 is configured to determine if the dataset for current case file contains a history of polygraph examination reports. If so, then the client register 206 facilitates the requesting and downloading of the history of polygraph examination reports for the current polygraph examination. Additionally, the client register 206 may facilitate requesting and downloading of the results and comments from the previous polygraph examinations.

The local dataset 208 stores the downloaded set of test questions and the history of polygraph examination reports that are utilized for the polygraph examination. Depending upon authorization level of the person who logged in (e.g., examiner), some of the data may be modified (e.g., answers to pre-defined test questions) while others are configured to be un-modifiable (e.g., personal information of examinee). Any data modifications to contents in the local dataset 208 are communicated and stored to the cloud-based service 250 in order to update the corresponding dataset 112 for the current polygraph examination.

During the initial stage of the polygraph examination, the examiner asks the set of pre-test questions to the examinee. The examinee answers by logging-in as “examinee” to the system of the computing device 106 and encodes his answers. Alternatively, the examiner encodes the examinee's answers to the set of pre-test questions. Either way, the local dataset 208 receives the examinee's answers and the contents of the local dataset 208 are modified accordingly. For example, the examinee's answers modify the stored set of pre-test questions by storing additional information such as, the examinee's encoded answers.

In one or more implementations, participating parties (e.g., investigators, parole/probation officers, therapists, human resources personnel, and the like) are allowed access to the examinee's electronic record after the examinee completes the pre-test questionnaire before (and not after) the polygraph is conducted. In these implementations, these participating parties will not be able to alter any information entered by the examinee; however, they may supplement that information. Who accessed and supplemented the examinee's electronic file is tracked.

In some instances, the examiner adds comments to the answers to the pre-test questions. Alternatively, the examiner encodes a different set of pre-test questions and the local dataset 208 receives and stores the corresponding examinee's answers to this different set of pre-test questions.

Based upon the examinee's answers to the set of pre-test questions, the customizer 210 is configured to re-arrange the set of regular test questions. For example, for every YES (or NO) answers in the set of pre-test questions, a portion of the regular test questions are removed for being redundant. In another example, the regular test questions are re-shuffled in a different order based upon combinations of YES and/or NO answers in the set of pre-test questions. In yet another example, the examiner can alternatively re-arrange manually the set of regular test questions. In these examples, the customizer 210 is configured to utilize the arrangement of the regular test questions in estimating the overall truthfulness of the examinee's answers.

After the re-arranging of the set of regular test questions, the polygraph equipment receives the customized regular test questions. The polygraph equipment, for example, performs an automated analysis of the examinee's response to the set of regular test questions and sends the results to the computing device 106. Alternatively, a polygraph examiner uses the polygraph equipment as his tool to help him interpret the truthfulness of the examinee's answers to the set of regular test questions. Alternatively still, the computing device (e.g., through security engine 212) performs separate automated analysis to estimate overall truthfulness of the examinee's answers. These alternative approaches may be used. Each approach may be done independently as a check on the other. Perhaps, the results of the three approaches are combined heuristically or statistically. Further, each approach may be done and the results of each generated, recorded, and sent.

Regardless of the approach utilized, the examiner may still add comments to each of the answers to the regular test questions. For example, the examiner confirms the overall response analysis in the results.

As an example of current implementations herein, the communications unit 214 stores the contents of the local dataset 208 to the cloud-based service 250 and particularly, for storage to the dataset 112. Furthermore, the communications unit 214 facilitates transmission of data request to the cloud-based service 250, and in response to this request, the communications unit 214 similarly facilitates the receiving of the requested data such as, the selected set of test questions or polygraph examination history reports.

The security engine 212 is configured to identify the level of access authorization by the individual who logs in. For example, the examiner for the current polygraph examination can access the set of test questions from the dataset 112; however, the examiner cannot access the polygraph examination history reports of the examinee to avoid bias during the polygraph examination. In another example, the requesting employer client is authorized to access all records within a particular date and to this end, the security engine 212 is configured to facilitate the access to the pertinent records for the particular date.

As an example of present implementations herein, the security engine 212 is configured to generate the report based, for example, upon the stored results in the local dataset 208. Furthermore, the security engine 212 generates the report based from the identified level of access of the requesting client.

The security engine 212, for example, implements the automated approach on the stored answers in the local dataset 208 to determine whether or not the examinee passed the polygraph examination. For example, the security engine 212 utilizes the arrangement of the regular test questions as a reference for estimating overall truthfulness of the examinee's answers. In this example, the security engine 212 generates the report by stating the pass or fail status, and by stating other pertinent information (e.g., examiner's comments, examinee's videos, etc.) that are allowed to be accessed by the requesting client. In other embodiments, the generated report includes information on polygraph examination statistics such as number of sex offender examinees, on parole examinees, and the like.

Furthermore, the security engine is configured to encrypt the generated report that the requesting client will receive. That is, after the security engine 212 identifies the level of access authorization by the requesting client, the reports are encoded in order to avoid eavesdroppers or hackers. For example, the requesting client will receive the report using additional password that allows the requesting client to view the report for a certain number of times.

Although not shown, the computing device 106 also includes a graphics subsystem, an audio subsystem, and a user input subsystem. The graphics subsystem is designed to display, in a user-interface, the selected set of test questions. The user input subsystem is designed to receive input from the examiner, the examinee, and other third parties who play a role to the current polygraph examination. For example, the examiner and/or the examinee utilizes the user input subsystem to encode authorized modifications to contents of the local dataset 208.

The network 240 may be a wired and/or wireless network. It may include the Internet infrastructure and it may be presented as the so-called “cloud.” The network 240 may include wired or wireless local area network, a cellular network, and/or the like. The network 240 links the computing device 106 with one or more network servers or cloud-based service 250.

The cloud-based service 250 includes a communications subsystem 252, a security access assistant 254, a dataset assistant 256, the dataset 112, and the database 114. The cloud-based service 250 need not be part of the so-called “cloud.” Rather, it may be described as one or more network servers or more simply as a computing system.

The communications subsystem 252 facilitates receiving of data requests and/or updates to the dataset 112. For example, any modifications to contents of the local dataset 208 are stored to corresponding dataset 112 in the cloud-based service 250. While only one computing device (which is computing device 106) is shown in FIG. 2, in reality the communications subsystem 252 receives multitude of data updates and/or requests, for example, from different polygraph examination areas. These data updates may correspond to different datasets 112 in the database 114.

The security access assistant 254 determines the authenticity of data updates and/or requests so that the contents of the dataset 112 will not be compromised or exposed to malicious software. For example, the security access 254 authenticates the authorization level that is given to the requesting client by the computing device 106. In this example, the data updates and/or data requests will not compromise the contents of the dataset 112. Although a single dataset 112 is shown in FIG. 2, multitudes of dataset 112 are required for multiple cases of polygraph examinations.

The dataset assistant 256 responds to requests from the computing devices to access contents of a particular dataset 112. For example, the dataset assistant 256 facilitates finding of the particular dataset 112 that corresponds to a particular polygraph examination scenario. In this example, different polygraph examination cases correspond to different dataset 112.

The database 114 stores multitudes of the dataset 112 that correspond to multitudes of polygraph examination cases. In other words, the database 114 stores the information for all polygraph examination reports and these reports are accessible through the computing devices according to level of authorization by the accessing party.

### Exemplary Process Chart

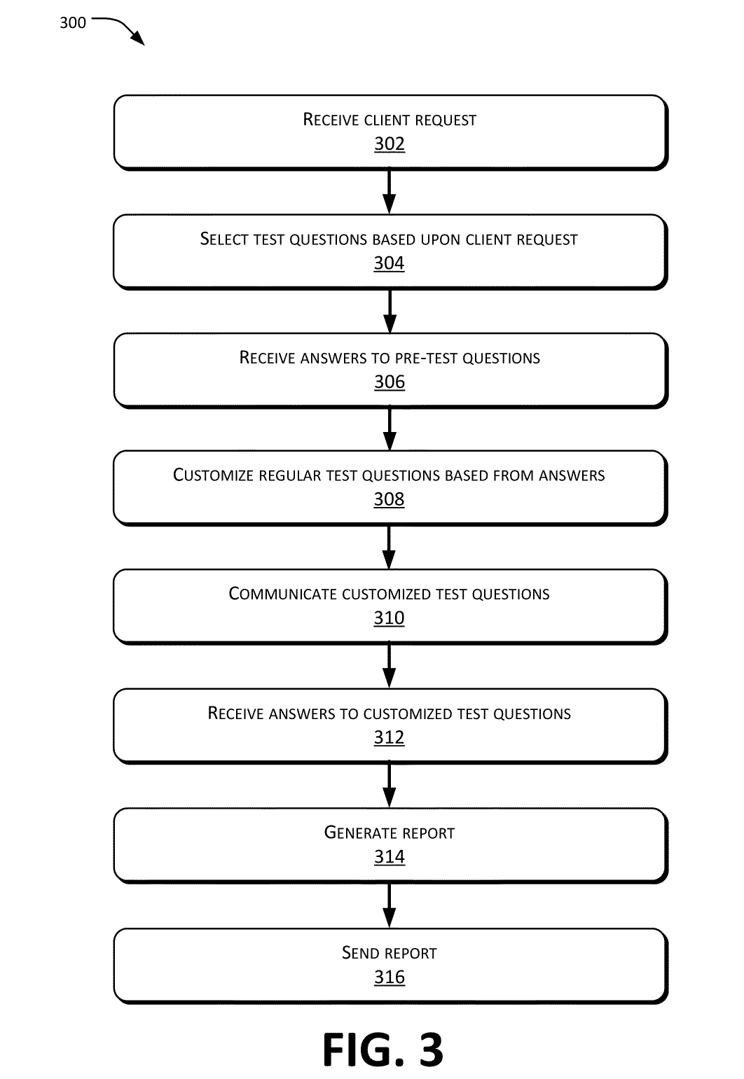

FIG. 3 shows an example process chart 300 illustrating an example method for generating polygraph examinations report that is polygraph equipment agnostic.

At block 302, receiving a client request by a computing device. For example, the client is a parole officer, a court judge, a psychologist, an examinee's employer, etc. who is requesting the examinee to undergo polygraph examinations. The client request includes a scheduling date for the polygraph examination.

At block 304, the selecting a set of test questions based upon the client request. For example, the set of test questions to be selected for the requesting parole officer client is different the private employer client. The set of test questions includes a set of pre-test questions and another set of regular test questions. For example, the set of test questions is selected and downloaded from a cloud-based service that contains a database of test questions.

At block 306, receiving answers to the set of pre-test questions. For example, the computing device receives the manually encoded examinee's answers to the set of pre-test questions. Alternatively, the examinee logs in to the system of the computing device and encodes his answers to the set of pre-test questions.

At block 308, customizing the set of regular test questions based from the received answers to the set of pre-test questions. For example, the computing device is configured to re-arrange the set of regular test questions. The re-arranging includes adding or deleting some of the pre-defined regular test questions.

At block 310, communicating the customized set of regular test questions to a polygraph equipment. For example, where a proprietary software format that is utilized by the polygraph equipment is known, the computing device may directly communicate the customized set of regular test questions to the polygraph equipment. In this example, the computing device obtains an indication of a type of polygraph equipment to be utilized (e.g., proprietary software format) and the proprietary software format is adapted in configuring the format of the customized set of regular test questions.

However, where the polygraph equipment is used as a tool, then the examiner manually exports the customized set of regular test questions to the polygraph equipment.

At block 312, receiving answers to the customized set of regular test questions. For example, the computing device receives the answers to the manually exported or communicated customized set of regular test questions. In this example, the answers are included in the results that are communicated by the polygraph equipment. The results, for example, include the regular test questions, examinee's answers, polygraph equipment response analysis of the examinee's answers, video recording, and the like.

At bock 314, generating a report based upon the answers to the customized set of regular test questions. For example, the computing device generates the report by compiling important details or summary of the examinee's answers, comments of the examiner, previous polygraph examination reports, and other information that are allowed for authorized access by the requesting client. In another example, the generated report includes pass or fail status of the examinee and video of the polygraph examination.

At block 316, sending the report to the requesting client. In some implementations, the computing device determines a security level of the requesting client before generating and/or sending the polygraph examination report. In this example, the polygraph examination report to be generated is limited by the determined access authority of the requesting client. Furthermore, a quality control review such as spelling and grammar corrections is implemented by the computing device before sending the polygraph examination report.

In all of the steps above, the contents and entries to the computing device and particularly, to local dataset component, are frequently communicated to update the database in a cloud-based service (e.g., service 250). For example, the entries include authorized modifications to the set of test questions, examiner's comments, etc.

### Exemplary System

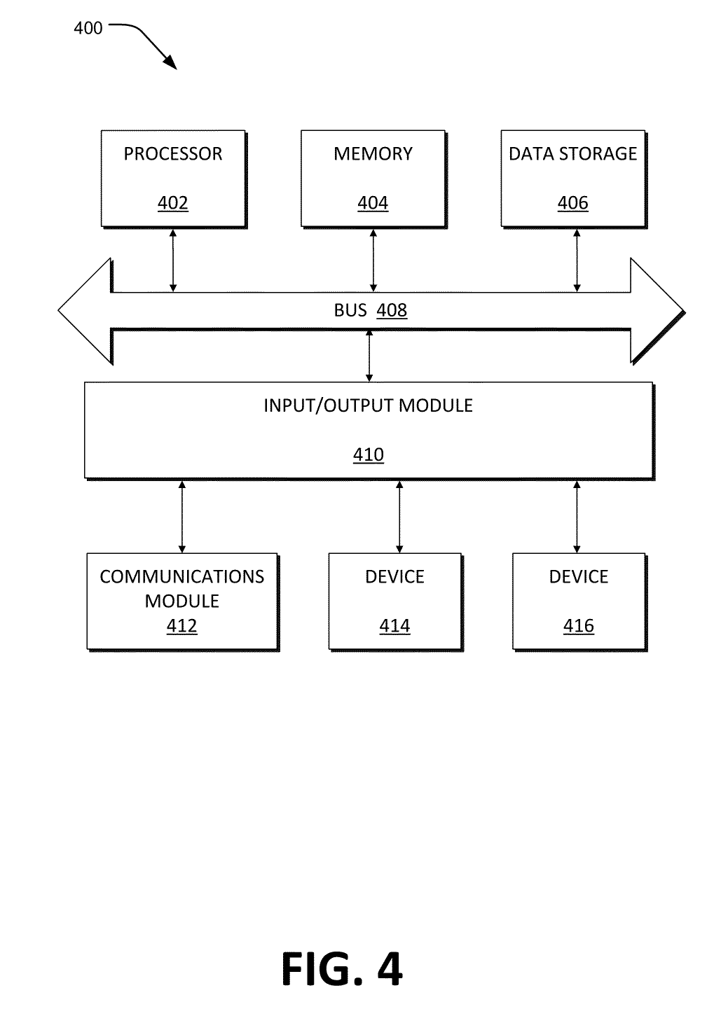

FIG. 4 is a high-level block diagram illustrating an example computer system 400 suitable for implementing the example environment 100 of FIG. 1. In certain aspects, the computer system 400 may be implemented using hardware or a combination of software and hardware.

The illustrated computer system 400 includes a processor 402, a memory 404, and data storage 406 coupled to a bus 408 or other communication mechanism for communicating information. An input/output (I/O) module 410 is also coupled to the bus 408. A communications module 412, a device 414, and a device 416 are coupled to the I/O module 410.

The processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. The processor 402 may be used for processing information. The processor 402 can be supplemented by, or incorporated in, special purpose logic circuitry.

The memory 404 may be Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device used for storing information, a computer program, and/or instructions to be executed by the processor 402. They memory 404 may store code that creates an execution environment for one or more computer programs used to implement technology described herein.

A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Unless indicated otherwise by the context, a module refers to a component that is hardware, firmware, and/or a combination thereof with software (e.g., a computer program.) A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The instructions may be implemented in one or more computer program products, i.e., one or more modules of computer program instructions encoded on one or more computer readable media for execution by, or to control the operation of, the computer system 400, and according to any method well known to those of skill in the art. The term “computer-readable media” includes computer-storage media. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

The data storage 406 may be a magnetic disk or optical disk, for example. The data storage 406 may function to store information and instructions to be used by the processor 402 and other components in the computer system 400.

The bus 408 may be any suitable mechanism that allows information to be exchanged between components coupled to the bus 408. For example, the bus 408 may be transmission media such as coaxial cables, copper wire, and fiber optics, optical signals, and the like.

The I/O module 410 can be any input/output module. Example input/output modules 410 include data ports such as Universal Serial Bus (USB) ports.

The communications module 412 may include networking interface cards, such as Ethernet cards and modems.

The device 414 may be an input device. Example devices 414 include a keyboard, a pointing device, a mouse, or a trackball, by which a user can provide input to the computer system 400.

The device 416 may be an output device. Example devices 416 include displays such as cathode ray tubes (CRT) or liquid crystal display (LCD) monitors that display information, such as web pages, for example, to the user.

### Additional and Alternative Implementation Notes

Any suitable type of technology can be utilized to implement the computing device. Examples of suitable, known technologies include (by way of example and not limitation): a desktop computer, a tablet computer, a netbook, a notebook computer, a mobile phone, a cellular phone, a smartphone, a personal digital assistant, and the like.

In an implementation, companies that specialize in background investigation utilize the network environment described herein. For example, a certain manufacturing employer requests the company to do background investigation on a prospect who applies for a technician job. In this example, the company verifies the background information of the prospect by simply logging into the system to access the database 114. More particularly, if the prospect has records such as those information that were stored in the dataset 112, then the polygraph examination reports, results, comments, etc. may be utilized to generate a background investigation report on the prospect.

In other implementations, private institutions, state agencies and other government offices may utilize the information that was stored in the database 114. For example, the congress for purposes of legislation can easily come up with statistics with regard to number of people on parole or probation by logging into the system.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “computer-readable media” includes computer-storage media. For example, computer-storage media may include, but are not limited to, magnetic storage devices (e.g., hard disk, floppy disk, and magnetic strips), optical disks (e.g., compact disk [CD] and digital versatile disk [DVD]), smart cards, flash memory devices (e.g., thumb drive, stick, key drive, and SD cards), and volatile and nonvolatile memory (e.g., RAM and ROM).

1. A method comprising:
receiving a request from a client; and
in response to the received request, configuring a polygraph equipment to produce a report based upon one or more polygraph examinations performed with the polygraph equipment;
the configuring including:
selecting a set of test questions from a database based upon the request, the set of test questions includes a set of pre-test questions and a set of regular questions;
initiating an examination of an examinee;
obtaining answers to the set of pre-test questions;
customizing the set of regular test questions based from the obtained answers;
communicating the customized set of regular test questions to the polygraph equipment;
receiving answers to the customized set of regular test questions;
generating the report based on the answers; and
sending the report to the client.

2. A method as recited in claim 1, wherein the request from the client includes a scheduling date for a polygraph examination of the examinee.

3. A method as recited in claim 1, wherein the set of pre-test questions include personal information questions to the examinee, the set of regular test questions include relevant, irrelevant, and control questions.

4. A method as recited in claim 1, wherein the customizing a set of regular test questions includes re-arranging the set of regular test questions.

5. A method as recited in claim 1, wherein the receiving answers to the customized set of regular test questions includes receiving results from the polygraph equipment, the results further include an examiner's analysis to each of the examinee's answers, polygraph equipment response analysis on the examinee's answers, and a video of the polygraph examination.

6. A method as recited in claim 1, wherein the generating the report includes a polygraph examination report that corresponds to a security level of the client, the security level includes a limit of authorized access to the polygraph examination report.

7. A method as recited in claim 1, wherein the generating the report includes compiling and highlighting important answers of the examinee.

8. A computing device comprising:
a client register configured to select a set of test questions from a database based on a client request, the set of test questions includes a set of pre-test questions and a set of regular questions;
a local dataset configured to receive and store answers to the set of pre-test questions;
a customizer configured to re-arrange the set of regular test questions based from the answers to the set of pre-test questions;
a communications unit configured to receive answers to the customized set of regular test questions;
a security engine configured to generate a report based upon the answers, wherein the report is sent to the requesting client.

9. A computing device as recited in claim 8, wherein the communications unit is further configured to send the customized set of regular test questions to a polygraph equipment.

10. A computing device as recited in claim 8, wherein the communications unit receives polygraph equipment generate results that include the answers to the customized set of regular test questions.

11. A computing device as recited in claim 8, wherein the communications unit is further configured to communicate contents of the local dataset to a corresponding dataset in the database.

12. A computing device as recited in claim 8, wherein the set of pre-test questions include personal information questions to the examinee, the set of regular test questions include relevant, irrelevant, and control questions.

13. A computing device as recited in claim 8, wherein the re-arranging of the set of regular test questions includes deleting regular test questions.

14. A computing device as recited in claim 8, wherein the security engine is further configured to determine security level of the client, the security level includes a limit of authorized access to the report.

15. A computing device as recited in claim 8, wherein the security engine is further configured to perform automated approaches in estimating truthfulness of the answers to the customized set of regular test questions.

16. One or more non-transitory computer-readable media with processor-executable instructions stored thereon which when executed by one or more processors cause performance of operations comprising:
selecting a set of test questions from a database based upon a client request, the set of test questions includes a set of pre-test questions and a set of regular questions;
obtaining answers to the set of pre-test questions;
customizing the set of regular test questions based from the obtained answers;
communicating the customized set of regular test questions to a polygraph equipment;
receiving answers to the customized set of regular test questions;
generating a polygraph examination report based from the answers; and
sending the polygraph examination report to the client.

17. One or more computer-readable media as recited by claim 16 further comprising:
receiving the client request, the client request includes a scheduling date for a polygraph examination of an examinee;
initiating an examination of the examinee;
encrypting of the polygraph examination report.

18. One or more computer-readable media as recited by claim 16, wherein the customizing the set of regular test questions includes re-arranging the set of regular test questions.

19. One or more computer-readable media as recited by claim 16, wherein the receiving answers to the customized set of regular test questions includes receiving results from the polygraph equipment, the results further include an examiner's analysis to each of the examinee's answers, polygraph equipment response analysis on the examinee's answers, and a video of the polygraph examination.

20. One or more computer-readable media as recited by claim 16, wherein the generating the report includes the report that corresponds to a security level of the requesting client, the security level includes a limit of authorized access to the report.

21. One or more non-transitory computer-readable media with processor-executable instructions stored thereon which when executed by one or more processors cause performance of operations comprising:
receiving a request from a client to examine an examinee;
in response to the received request:
accessing an electronic record of the examinee;
configuring a polygraph equipment to produce a report based upon one or more polygraph examinations performed with the polygraph equipment;
the configuring including:
selecting a set of test questions from a database based upon the client request, the set of test questions includes a set of pre-test questions and a set of regular questions;
obtaining answers to the set of pre-test questions;
storing the obtained answers in the electronic record of the examinee;
customizing the set of regular test questions based from the obtained answers;
communicating the customized set of regular test questions to a polygraph equipment;
receiving answers to the customized set of regular test questions;
storing the answers to the customized set of regular test questions;
generating a polygraph examination report based from the answers; and
sending the polygraph examination report to the client; and
limiting access of the client to the electronic record so that the client may view the record after the obtaining answers to the set of pre-test questions and before the receiving answers to the customized set of regular test questions.

22. One or more computer-readable media as recited by claim 21, wherein the limiting access allows the clients to supplement the electronic record but not alter the record otherwise.
